(19) United States
(12) Patent Application Publication
(10) Pub. No.: US 2004/0141316 A1
(43) Pub. Date: Jul. 22, 2004

(54) Mobile lamp

(76) Inventor: Harald Twardawski, Rastatt (DE)

Correspondence Address: HARNESS, DICKEY & PIERCE, P.L.C., P.O. BOX 828, BLOOMFIELD HILLS, MI, 48303, US

(21) Appl. No.: 10/718,253

(22) Filed: Nov. 20, 2003

(30) Foreign Application Priority Data
Nov. 22, 2002 (DE) 102 54 634.7

(51) Int. Cl. F21V 33/00

(52) U.S. Cl. 362/184; 362/244

(57) ABSTRACT

A mobile lamp includes a first lighting unit for the radiation of a first light beam in a first radiation direction which, for the formation of the first light beam, has at least one first light emitting diode element and one image producing device which is associated with the first light emitting diode element and to which light emitted by the first light emitting diode element can be supplied, and a second lighting unit for the radiation of a second light beam in a second radiation direction differing from the first radiation direction which, for the formation of the second light beam, has at least one second light emitting diode element and one image producing device which is associated with the second light emitting diode element and to which light emitted by the second light emitting diode element can be supplied.

### CROSS REFERENCE TO RELATED APPLICATION

This application claims priority to German Patent Application No. 102 54 634.7, filed Nov. 22, 2003, which is hereby incorporated by reference herein.

### FIELD OF THE INVENTION

The present invention relates to a mobile lamp.

### BACKGROUND OF THE INVENTION

Mobile lamps are generally known. Lamps are in particular understood by this which are transportable and which can be operated during their use without a connection to a mains network. Examples for such mobile lamps are, for example, flashlights, head lamps or also lamps for vehicles.

For many applications, it is desirable to be able to illuminate different spatial regions with such a mobile lamp. It is necessary for this purpose, for example with a conventional head lamp or flashlight using a light bulb or a halogen light bulb as the light source, to pivot the head lamp or flashlight into a corresponding spatial direction. To improve the illumination of a defined area, the light emitted by the light bulb or by the halogen light bulb can then be correspondingly focused, for which purpose, for example, a reflector having focusing properties can be used which is displaceable relative to the light bulb or to the halogen light bulb and which surrounds the light bulb or the halogen light bulb.

However, such mobile lamps have a series of disadvantages. On the one hand, light bulbs or halogen light bulbs consume a great deal of power such that either a large and heavy power supply is required, for example by batteries, or the lamp only has a short operating time. On the other hand, an adjustable focusing of the emitted light requires a comparatively complex movable guiding of the reflector. Moreover, the lamp must be pivoted, which can in particular be disadvantageous with head lamps.

### SUMMARY OF THE INVENTION

It is therefore the underlying object of the present invention to provide a mobile lamp by means of which different spatial regions can easily be illuminated.

The object is satisfied by a mobile lamp having the features in accordance with claim 1.

The mobile lamp in accordance with the invention includes a first lighting unit for the radiation of a first light beam in a first radiation direction which has at least one first light emitting diode element for the formation of the first light beam and one image producing device, which is associated with the first light emitting diode element and to which light emitted by the first light emitting diode can be supplied, and includes a second lighting unit for the radiation of a second light beam in a second radiation direction different from the first radiation direction which has at least one second light emitting diode element for the formation of the second light beam and one image producing device which is associated with the second light emitting diode element and to which light emitted by the second light emitting diode element can be supplied.

A mobile lamp is understood as a lamp which is portable or movable and which does not require a connection to a fixed mains supply during operation.

Respective light beams can be radiated by means of the lighting units which are formed by means of the light emitting diode elements and by means of the associated image producing devices.

The light emitting diode elements can generally be pure light emitting diodes or also light emitting diodes with an integrated luminous element, in particular made of glass, serving for the collection of the light emitted by the light emitting diode. Furthermore, a plurality of light emitting diode elements can also be provided in each lighting unit.

For the formation of the respective light beams, light of the respective light emitting diode elements is supplied to the image producing devices associated with the respective light emitting diode elements, preferably individually, and is focused or dispersed, and optionally deflected, by them. The light emitted by the image producing devices then serves in each case for the formation of the light beam emitted by the respective lighting unit. If a plurality of light emitting diode elements are used in one lighting unit, the light beam is formed via the image producing devices by the light emitted in total by the light emitting diode elements present in the lighting unit and therefore does not necessarily have to be conical.

The first light beam and the second light beam can each be radiated in different radiation directions which are defined by the positions of the light emitting diode elements and of the image producing devices associated with them. The radiation directions are in particular each defined relative to the position of the mobile lamp.

Two different spatial regions disposed in the different radiation directions can therefore be illuminated without a pivoting of the lamp due to the different radiation directions and in particular do not need to overlap depending on the selection of the angle between the first radiation direction and the second radiation direction.

The image producing devices furthermore allow a widening or focusing of the light emitted in each case by the light emitting diode elements which can in particular be chosen in accordance with respectively pre-determined spatial regions in the respective radiation directions such that the pre-determined spatial region can be illuminated very effectively, while as little light as possible is guided into adjacent regions not to be illuminated. An adjustable focusing device is therefore not necessary.

By the use of light emitting diode elements as a light source, it is possible, on the one hand, to achieve a substantially larger light yield in comparison with light bulbs or halogen light bulbs with a pre-determined energy take-up such that, for example on operation with a battery or with a rechargeable battery, either a substantially larger luminous intensity or a substantially longer lighting time can be achieved. On the other hand, light emitting diode elements have substantially longer service lives and are less sensitive to shocks than light bulbs or halogen light bulbs.

Generally, all light emitting diode elements can be switched on and off together such that two corresponding spatial regions can be illuminated simultaneously by the first light beam and by the second light beam. It is, however, frequently desirable only to illuminate one spatial region. For example, the first spatial region can be disposed remotely from the second spatial region such that a user of the lamp can only observe one of the spatial regions and then also only wants to illuminate this one. It is therefore preferred for a switching device to be provided by means of which the lighting units can be switched on and off individually. The switching device is particularly preferably made such that only the first lighting unit, only the second lighting unit or the first lighting unit and the second lighting unit can be switched on or off by means of only one switch. In this manner, a particularly low energy consumption results since only those light emitting diode elements actually need to be switched on whose light is required for the illumination of a spatial region of interest to a user. However, in order to switch on a lighting unit, not all light emitting diodes of the lighting unit necessarily have to be switched on; it is rather the case that a graduated switching on of the lighting unit is also possible by a successive switching on of a plurality of light emitting diode elements of the lighting unit.

Generally, the first and the second lighting units can be held in a fixed position relative to one another such that the first radiation direction and the second radiation direction include a fixed angle with one another. In this case, it is preferred for the image producing device of the two lighting units to be made in one piece in one component. In this manner, an alignment of the image producing devices to one another and to the light emitting diode elements as well as the alignment of the lighting units to one another is substantially facilitated. Furthermore, the production of the mobile lamp is thus substantially facilitated when the component is manufactured, for example, by injection molding of a suitable transparent plastic.

It is alternatively preferred for one of the lighting units to be movably supported relative to the other such that the angle between the first radiation direction and the second radiation direction can be changed. One of the lighting units can in particular be pivotal relative to the other. Such a mobile lamp can be used particularly flexibly since a user can match the lamp to a relative position of different spatial regions to be illuminated by a change of the angle included between the first radiation direction and the second radiation direction. The lighting units can particularly preferably be pivotable relative to one another such that the radiation directions can also extend in parallel such that an increase in the luminous density is made possible in this radiation direction.

Generally, the first radiation direction and the second radiation direction can include any desired angle which is larger than 0° and smaller than 180°. It is, however, particularly preferred for the second radiation direction to include an angle with the first radiation direction which is larger than 5° and smaller than 85°. Spatial regions disposed in the respective radiation directions can then be observed by a user without any larger movement of the head simply by a movement of the eyes such that a particularly large advantage results for a user in this case.

It is furthermore preferred for the lighting units to be made such that the light beams which can be radiated from the lighting units are divergent and a cross-sectional area of the first light beam is smaller in a pre-determined distance from the lamp than a cross-sectional area of the second light beam at the pre-determined distance. The respective cross-sectional areas are each orthogonal to the corresponding radiation directions. Since the first light beam is thus focused more than the second light beam, it can illuminate a given area at a larger distance with a larger intensity than is possible by the second light beam and can therefore be used as a type of main beam. The second light beam, vice versa, allows the illumination of a comparatively large area in a near region. The light emitting diode elements can for this purpose particularly preferably be arranged within a focal length of the respective image producing devices.

It is furthermore preferred for the at least one image producing device to include a focusing optical component and to be made such that the light of the corresponding lighting unit can be focused onto a surface orthogonal to the radiation direction at a pre-determined distance. In this manner, a substantially sharply delineated light spot can be produced at a pre-determined distance on a surface to be illuminated.

It is particularly preferred for the lighting units to be made such that a light spot with an area between 1 m² and 4 m² can be produced by means of the first lighting unit on a first surface orthogonally oriented with respect to the first propagation direction at a distance of approximately 10 m and that a light spot with an area between 0.4 m² and 2 m² can be produced by means of the second lighting unit on a second surface orthogonally oriented with respect to the second propagation direction at a distance of approximately 1 m. Particularly favorable properties of use result in this manner, in particular for the case that the mobile lamp is used as a head lamp.

The image producing devices can generally be any desired devices by means of which light beams emitted by the light emitting diode elements can be expanded or focused more strongly and can, optionally, be deflected. It is preferred for the image producing devices to include lenses spaced apart from the light emitting diode elements. These can particularly preferably be convergent lenses. In one embodiment, they can have a focal length and be arranged relative to the light emitting diode elements such that light of the corresponding light emitting diode elements can be focused at pre-determined distances from the light emitting diode elements. In another particularly preferred embodiment, the light emitting diode element is arranged inside the focal length of the convergent lens such that a virtual image of the light emitting diode element is created and the light beam emitted is divergent. Such an arrangement permits a very compact design even with larger focal lengths.

To achieve a good illumination effect, it is preferred for the first and/or second lighting units each to include at least two light emitting diode elements and at least two corresponding image producing devices.

It is particularly preferred, when lenses are used as image producing devices, for tubes to be arranged between the lenses and the light emitting diode elements through which light of a light emitting diode element can be guided in each case to the corresponding lens, but which prevent a dispersion of light of a light emitting diode element into the region of a lens which is associated with another light emitting diode element. A particularly sharply delineated light beam is achieved in this manner. If as little light as possible should be lost, it is particularly preferred for the tubes to have an internal surface which is highly reflective for light of the light emitting diode elements. To achieve a particularly sharp delineation of the light beam, it is, in contrast, particularly preferred for the tubes to have a surface which is only slightly reflective, or not at all reflective, for light of the light emitting diode elements and which can in particular be black and/or matt.

Alternatively, a reflector can preferably be provided between a lens of the image producing devices and the corresponding light emitting diode element which opens in the direction of radiation of the light emitting diode element and by means of which light emitted by the light emitting diode element can be focused and guided to the lens.

It is furthermore preferred for the imaging producing devices of at least two light emitting diode elements of one of the lighting units to be made such that a pre-determined surface at a pre-determined distance from the mobile lamp can be illuminated by light beams of these light emitting diode elements. In this case, the additional light emitting diode element therefore does not serve for the enlarging of the surface which can be illuminated, but an increased luminous intensity is achieved over the same surface in that the light beams which are emitted by the light emitting diode elements and which at least partly form the light beam of the lighting unit are guided onto the same surface. This is in particular of importance for the illumination at a larger distance from the lamp in accordance with the invention in which the luminous intensity is lower due to the distance than in a near region. The image producing devices can, for this purpose, be inclined at an appropriate angle to one another; it is, however, also possible to arrange the longitudinal axis or the beam direction of the light emitting diode elements at a suitable spacing from the optical axis of the image producing devices, but substantially parallel thereto.

To permit an illumination which is as pleasant as possible for an observer and in particular also to facilitate the recognition of colors, it is preferred for the light emitting diode elements to be light emitting diode elements for the emission of substantially white light.

The mobile lamp in accordance with the invention can be made for the most varied uses. In a preferred further development, provision is made for the lamp to be made as a vehicle lamp, in particular as a bicycle lamp. It can in particular be used as a front lamp on a bicycle, with the first lighting unit being able to serve for the making available of the main beam, which is incident to the road at a distance of approximately 8 to 10 m in front of the lamp, and the second lighting unit being able to serve for the making available of light for the near region, that is for a region at a distance of 1 to 2 m in front of the bicycle. The lamp in accordance with the invention can have appropriate fastening means for the fastening of the lamp to a bicycle.

In another preferred further development, provision is made for the lamp to be made as a head lamp. It is then particularly suitable as an illumination in the dark when a user alternatively requires light in the region of the hands or light at a distance, such as is the case when camping. It can in particular have an elastic headband for this purpose by means of which it can be fastened to a head of a user.

It is in particular especially preferred for the lamp to have an areal support element which is pivotable relative to the lighting units in a plane which is aligned substantially parallel to the first and second radiation directions. In this manner, the mobile lamp can be securely fastened relative to an object or to a head of a user while applying the support element thereto, with the orientation of the two radiation directions simultaneously being adjustable relative to the object or to the head.

It is particularly preferred for a housing to be provided in which the lighting units are arranged and for latch elements to be arranged at the housing and at the support element which are complementary to one another and by means of which the support element can be secured in its relative position to the housing. In this manner, after an adjustment of the mobile lamp in accordance with the invention relative to an object or a head carrying the same, a maladjustment can be prevented very simply and reliably. One of the latch elements can in particular be provided by an arm at which a plurality of latch hooks are formed which are movable by pivoting the support element relative to the housing into the region of a complementary latch element, for example at a latch opening, with which they then cooperate.

It is in particular preferred on the formation of the lamp as a head lamp for a housing to be provided for the reception of the lighting units and for two lugs to be provided which are arranged at opposing sides of the housing, are connected to the housing and at which an elastic band can be held for the fastening of the lamp to an object or to a head of a person and which are so flexible that their shape can be matched to the shape of the object or of the head by the tension of the elastic band on being secured to the object or to the head. In this manner, a force between the lamp and an object or a head at which the former is held is spread over a larger surface such that pressure marks are avoided. Moreover, a particularly secure fit of the lamp also results when larger torques act on it due to the relatively large spacing of the contact surfaces formed by the lugs.

The lamp in accordance with the invention can be supplied with power in different manners. It is in particular preferred in the version as a head lamp for the lighting units to be arranged in a housing in which a battery compartment is provided. This very compact embodiment of the lamp in accordance with the invention is in particular suitable when an only very small lamp with a relatively low luminous power or lighting period is required.

In accordance with another preferred further development, it is preferred for the lighting units to be held at an elastic band in a housing and for a battery holder to be held at the band. Batteries or rechargeable batteries can be placed into said battery holder which serve for the feeding of the light emitting diode elements in the lighting units. The housing with the lighting units can thereby be kept particularly small and light such that only comparatively small inertia forces act even on fast movements and the housing with the lighting units can thus be pivoted quickly.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a plan view of a mobile lamp in accordance with a preferred embodiment of the invention in the form of a head lamp;

FIG. 2 is a side view of a lamp head of the mobile lamp in FIG. 1;

FIG. 3 is a schematic sectional view through the lamp head in FIG. 2;

FIG. 4 is a plan view of a tube body of the lamp head;

FIG. 5 is a side view of the lamp head in FIG. 2 with a support element pivoted out;

FIG. 6 is a schematic sectional view through a housing rear wall and the support element of the lamp head in FIG. 5;

FIG. 7 is a schematic sectional view through a battery holder of the lamp in FIG. 1; and

FIGS. 8A, B, C is a schematic sectional view through the only partly shown lamp head in FIG. 2 with a beam path of light which can be emitted by the lamp head and shapes of light spots which arise when light beams in FIG. 8A are incident on surfaces shown in FIG. 8A.

### DETAILED DESCRIPTION OF THE PREFERRED EMBODIMENTS

The following description of the preferred embodiment(s) is merely exemplary in nature and is in no way intended to limit the invention, its application, or uses.

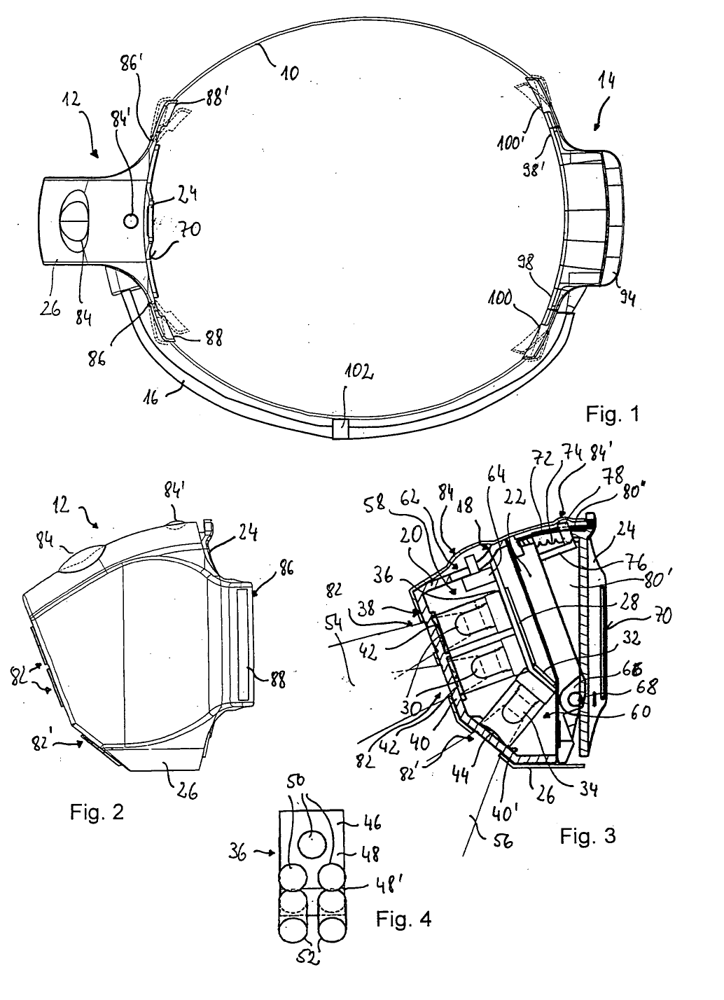

In FIG. 1, a mobile lamp in accordance with a preferred embodiment of the invention formed as a head lamp includes a lamp head 12 held at an elastic headband 10 which is very extensible, a battery holder 14 and a connection cable 16 which is likewise held at the headband 10 and which connects the battery holder 14 to the lamp head 12 and serves for the power supply of the lamp head 12 by batteries or rechargeable batteries held in the battery holder 14.

The lamp head 12 shown more precisely in FIGS. 2, 3, 5 and 6 includes a housing 18, termed a lamp head housing in the following, with a housing front part 20 and a housing rear wall 22, a support element 24 pivotably supported at the lamp head housing 18 or at its housing rear wall 22, and a jacket 26 which is open in the region of the housing rear wall 22 and of the support element 24, but which otherwise surrounds the lamp head housing 18 and which is termed a lamp head housing jacket in the following.

Three first light emitting diode elements 30 for white light, which are not all visible in the Figures, are arranged on a first board 28 in the lamp head housing 18 and two second light emitting diode elements 34 for white light, which are not all visible in the Figures, are arranged on a second board 32, as are appropriate supply circuits for the light emitting diode elements. The light emitting diode elements 30 and 34 engage partly into a tube body 36 fastened in the lamp head housing 18.

The housing front part 20 made of a transparent thermoplastic such as polycarbonate has a front wall 38 with an upper planar section 40 and a lower planar section 40′ which is angled at a pre-determined angle of approximately 45° in the example in the direction of the housing rear wall 22.

Three first convergent lenses 42 of the same focal length arranged at the corners of an equilateral triangle are formed in the upper section 40 of the front wall 38 and, furthermore, two adjacent second convergent lenses 44 are formed in the lower section 40′ whose respectively equal focal lengths differ from that of the first convergent lenses 42. The optical axes of the first convergent lenses 42 extend toward one another with equal, low, pre-determined first inclination angles with respect to a perpendicular to the plane of the section 40. In a similar manner, the optical axes of the second convergent lenses 44 are inclined toward one another with respectively equal, low, predetermined second inclination angles with respect to a perpendicular, with a plane set up through the optical axes being substantially oriented orthogonally to the plane of the section 40′.

The one-piece tube body 36 (cf. FIG. 4) has a base plate 46 which likewise includes an upper section 48 and a lower section 48′ likewise angled by the predetermined angle, in the example that is by approximately 45°, with respect to the upper section 48. Three first tubes 50 are arranged on the upper section 48 and their longitudinal axes extend orthogonally to the upper section 40 of the front wall through the centers of the corresponding first convergent lenses 42 and they contact the front wall 38 when the tube body 36 is inserted into the lamp head housing 18. Two second tubes 52 are arranged on the lower region of the base plate 46 and their longitudinal axes extend orthogonally to the lower section 40′ of the front wall through the centers of the corresponding second convergent lenses 42 in the installed state of the tube bodies 36 and they contact the front wall 38.

The first and second tubes 50 and 52 are black and matt at their inner sides and have equal lengths. They each open in corresponding openings in the base plate 46 which, together with the corresponding ends of the tubes 50 and 52, form mounts for lamp bodies of the light emitting diode elements 30 and 34 respectively. The first board 28 and the second board 32 are fastened to the base plate 46, with the corresponding light emitting diode elements 30 or 34 being arranged in substantially shape-matched manner in the corresponding first tubes 50 or second tubes 52 and with their longitudinal axes, and thus radiation directions, being aligned parallel to one another thereby.

Light emitted by the light emitting diode elements 30 or 34 is guided through the appropriate tubes 50 or 52 and through the convergent lenses 42 and 44 thus associated in each case with the light emitting diode elements and forms first or second emitted light beams 54 and 56. The first light emitting diode elements 30 and the first convergent lenses 42 as first image producing devices therefore form a first lighting unit 58, whereas the second light emitting diode elements 34, together with the second convergent lenses 44, as second image producing devices, represent a second lighting unit 60 which is arranged at the pre-determined angle of approximately 45° in the example with respect to the first lighting unit 58.

A switch 64 partly arranged in a switch opening 62 at an upper side of the housing front part 22 forms, together with appropriate circuits on the first board 28 and on the second board 32, a switching device by means of which either only the first light emitting diode elements 30, and thus the lighting unit 58, or only the second light emitting diode elements 34, and thus the lighting unit 60, or also both light emitting diode elements 30 and 34, and thus the lighting units 58 and 60, can be switched on or off together.

The support element 24 is areal in design and is pivotably supported by means of bearing eyes 66 on appropriate bearings spigots 68 at the housing rear wall 22 of the lamp head housing 18 about a corresponding axis in a plane substantially orthogonal to a plane of the support element (cf. FIGS. 2 and 3 or FIGS. 5 and 6).

Furthermore, a contact surface 70 is formed at a side of the support element 24 remote from the lamp head housing 18 which contacts the forehead of a user during the wearing of the head lamp when said user has pulled the elastic band 10 over his head.

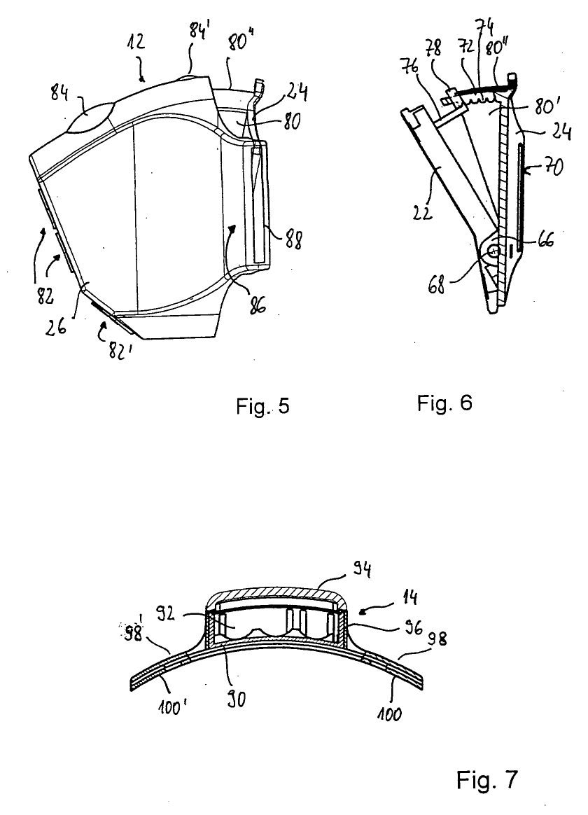

To secure the support element 24 in a set pivoted position with respect to the housing rear wall 22, a toothed rack 72 arched in the shape of a circle segment and with latching teeth 74 as latch elements is arranged at the support element 24 and a resilient latch arm 76 with a hook shape at the free end and with an end projection 78 having a latch opening for the latch teeth 74 is arranged as a complementary latch element at the housing rear wall 22. The toothed rack 72 is arched and arranged relative to the latch arm 76 such that the toothed rack 72 engages through the latch opening into the end projection 72 and a lower edge of the latch opening can latch into the gaps between the latching teeth 74 by a bias of the resilient latch arm 76. A movement of the support element 24 with respect to the housing rear wall 22 is thus prevented. The resilient latch arm 76 can be moved away from the toothed rack 72 by pressure on the end projection 78 with the latch opening such that the toothed rack 72 can be displaced in the latch opening and the support element 24 is pivotable with respect to the housing rear wall 22 (cf. FIGS. 5 and 6).

Furthermore, lateral cover walls 80 and 80′ in the form of circle sectors and an upper cover wall 80″ are provided at the support element 24 (cf. FIGS. 3 and 6).

The support element 24 moreover has slots, not shown in the Figures, through which the headband 10 can be guided at its end and can be secured by folding back and sewing.

The lamp head housing jacket 26 partly surrounding the lamp head housing 18 is made of a thermoplastic, elastomeric material, e.g. of an appropriate polyurethane polymer. Openings 82 and 82′ corresponding to the first and second convergent lenses 42 and 44 are formed at a region of the lamp head housing jacket 26 contacting the front wall 38 such that light can be radiated through them. With the exception of these openings 82 and 82′ and an opening in the region of the support element 24, the lamp head housing jacket 26 completely surrounds the housing 18.

The lamp head housing jacket 26 extends beyond the housing rear wall 22 up to a peripheral external rim of the support element 24 when the latter is pivoted toward the housing rear wall 22. The cover walls 80, 80′ and 80″ are shaped such that, together with the lamp head housing jacket 26, they substantially cover a hollow space formed between the support element 24 and the housing rear wall 22 (cf. FIGS. 2 and 5). The end surfaces of the side cover walls 80 and 80′ contact the housing rear wall 22 when the support element 24 is pivoted toward the housing rear wall 22 (cf. FIG. 3).

Since the lamp head housing jacket 26 is made of an elastomeric material, the switch 64 and the end projection 78 with the latch opening can be operated through corresponding bulges 84 and 84′.

The lamp head housing jacket 26 furthermore serves for the sealing of the lamp head housing 18, since it has a close contact thereto and thus largely prevents a penetration of water between the lamp head housing jacket 26 and the lamp head housing 18. No water can thereby also penetrate between the housing front part 20 and the housing rear wall 22 or through the switch opening 62 into the interior of the lamp head housing 18.

Furthermore, the lamp head housing jacket 26 continues to the side of the lamp head housing 18 in two flexible lugs 86 and 86′ which each have loops 88 and 88′ with slot-like openings at their ends whose height corresponds to the width of the headband 10 and through which the headband 10 can be guided. The lugs 86 and 86′ are so flexible (cf. FIG. 1) that they can be pulled toward the head and contact it by a drawing at the headband 10 such as occurs when the head lamp is placed on a head. A comparatively large contact area of the head lamp in accordance with the invention at the head thereby results, whereby pressure marks are avoided, on the one hand, and a particularly reliable fit is ensured due to the large contact area also extending far to the sides, on the other hand.

The battery holder 14 shown more precisely in FIG. 7 has a housing made of a thermoplastic with a battery housing lower part 90 with a battery compartment 92 and with a battery holder cover 94 pivotably connected to the battery housing lower part 90. The battery housing lower part 90 is partly surrounded in an analog manner to the lamp head housing 18 of the lamp head 12 in a jacket 96 made of an elastomeric thermoplastic material, termed a battery housing jacket in the following, which—like the lamp head housing jacket 26—has two lugs 98 and 98′ at whose free ends loops 100 and 100′ are provided for the reception of the headband 10 and which are formed like the loops 86 and 86′. A rim of the battery housing jacket 96 facing the battery holder cover 94 simultaneously serves as a seal for the sealing of a gap which may occur between the battery housing lower part 90 and the battery holder cover 94.

The connection cable 16 shown only schematically in FIG. 1 and held at the headband 10 via a clamping holder 102 has two wires which are connected to corresponding poles of the battery compartment 92 in the battery holder 14 and which are connected to corresponding contacts on the first and second boards 28 and 32. The connection cable 16 can in particular have a coiled part region such that the battery holder is displaceable on the headband 10.

The housing front part 20, together with the lamp head housing jacket 26, and the battery housing lower part 90 with the battery holder cover 94, together with the battery housing jacket 96, can be manufactured by two-component injection molding for the manufacture of the lamp head 12. The tube body 36 can then be inserted into the housing front part 20 and fastened therein, whereupon the first and second boards 28 and 32 with the first light emitting diode elements 30 and the second light emitting diode elements 34 respectively are pushed into the base plate 46 with the tubs 50 and 52 and fastened to the base plate 46. The housing rear wall 22 with the support element 24 held thereon can then be screwed to the housing rear wall 22.

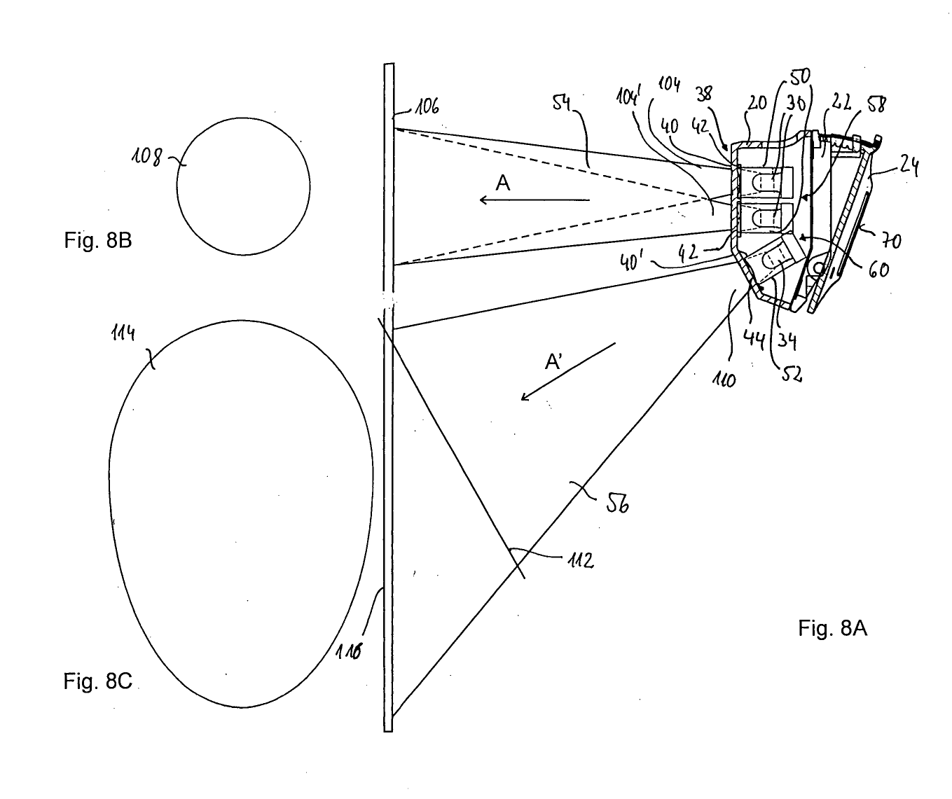

The beam path of the light emitted by the light emitting diode elements 30 and 34 is shown in more detail schematically in FIG. 8A.

The first light emitting diode elements 30 produce first light beams with substantially parallel radiation directions, of which only the light beams 104 and 104′ are visible in FIG. 8A and whose opening angle and direction after passing the first tubes 50 is changed by the first image producing devices, i.e. by the first convergent lenses 42, when they pass through them. The first light beam 54 of the first lighting unit 58 is formed from the first light beams formed in this manner. Since the optical axes of the first convergent lenses 42 are inclined toward one another onto the section 40 with the same angles with respect to the perpendicular, on the one hand, and the first light emitting diode elements 30 are arranged at the corners of an equilateral triangle with radiation directions substantially parallel to one another, a first radiation direction A of the first lighting unit 58 thus results which extends from the right to the left and which is aligned substantially orthogonally to the upper section 40 of the front wall 38 of the lamp head housing 18.

The inclination of the optical axes of the first convergent lenses 42 toward one another and with respect to a perpendicular on the section 40 is selected such that the first light beams 104 and 104′ focused by the convergent lenses 42 and emitted by the first light emitting diode elements 30 start to overlap at a distance from the lamp of approximately 60 cm and completely overlap at a distance of approximately 10 m. On illuminating an area 106 orthogonal to the radiation direction A at a spacing of approximately 10 m (which is not shown true to scale in FIG. 8A) a substantially circular light spot 108 results, as shown in FIG. 8B, with an area of approximately 2.5 m² which corresponds to that of the cross-sectional area of the first light beam 54 at this spacing. The opening angle of the first light beam 54 formed by the light beams of the three light emitting diode elements 30 shown in FIG. 8A has been drawn exaggeratedly large.

The first light beam 54 is therefore suitable for the illumination of a remote spatial region.

The second light emitting diode elements 34 produce second light beams with substantially parallel radiation directions, of which only the light beam 110 is visible in FIG. 8A and whose opening angle and direction after passing the second tubes 52 is changed by the second image producing devices, i.e. by the second convergent lenses 44, when they pass through these. The second light beam 56 of the second lighting unit 60 is formed from the second light beams formed in this manner. Since the optical axes of the second convergent lenses 44 are inclined toward one another with the same angles with respect to the perpendicular on the lower section 40′, on the one hand, and the second light emitting diode elements 34 are arranged in a direction parallel to an edge between the sections 40 and 40′ with radiation directions substantially parallel to one another, a second radiation direction A′ of the second lighting unit 60 results which is aligned substantially orthogonal to the lower section 40′ of the front wall 38 of the lamp head housing 18 and thus encloses with the first radiation direction A an angle of approximately 45° in the example which corresponds to the pre-determined angle between the sections 40 and 40′. The first and second light beams 54 and 56 therefore do not overlap so that spatial areas which differ from one another and do not overlap can be illuminated with them.

The inclination of the optical axes of the second convergent lenses 42 toward one another and with respect to a perpendicular on the lower section 40′ is selected such that the second light beams 110 focused by the second convergent lenses 44 and emitted by the second light emitting diode elements 34 completely overlap at a distance of approximately 1 m from the lamp. As shown schematically in FIG. 8A, on the illumination of an area 112 orthogonal to the second radiation direction A′, a substantially circular light spot results with an area of approximately 0.75 m² which corresponds to that of the cross-sectional area of the second light beam 56 at this distance. The cross-sectional area of the first light beam is therefore smaller than that of the second light beam at a 1 m distance.

On an area 116 perpendicular with respect to the first propagation direction A, the second light beam 56 then results in a substantially oval light spot 114 which is sharply delineated at this distance (cf. FIG. 8C).

The second light beam 56 can therefore be used as a near light for the illumination of objects in the region of the hands of a user of the head lamp.

The inclination of the lamp head 12, and thus that of the first and second radiation directions A and A′, can be matched to the slope of the forehead of a wearer by the pivotability of the support element 24.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A mobile lamp having a first lighting unit (58) for the radiation of a first light beam (54) in a first radiation direction (A) which, for the formation of the first light beam (54), has at least one first light emitting diode element (30) and one image producing device (42) which is associated with the first light emitting diode element (30) and to which light emitted by the first light emitting diode element (30) can be supplied; and having a second lighting unit (60) for the radiation of a second light beam (56) in a second radiation direction (A′) differing from the first radiation direction which, for the formation of the second light beam (56), has at least one second light emitting diode element (34) and one image producing device (44) which is associated with the second light emitting diode element (34) and to which light emitted by the second light emitting diode element (34) can be supplied.

2. A mobile lamp in accordance with claim 1, characterized in that a switching device (64) is provided, by means of which the lighting units (58, 60) can be switched on and off individually.

3. A mobile lamp in accordance with claim 1, characterized in that the image producing devices (42, 44) of the two lighting units (58, 60) are made in one piece in one component (20).

4. A mobile lamp in accordance with claim 1, characterized in that one of the lighting units is movably supported relative to the other such that the angle between the first and the second radiation directions can be changed.

5. A mobile lamp in accordance with claim 1, characterized in that the second radiation direction (A′) includes an angle with the first radiation direction (A) which is larger than 5° and smaller than 85°.

6. A mobile lamp in accordance with claim 1, characterized in that the lighting units (58, 60) are made such that the light beams (54, 56) which can be radiated by the lighting units (58, 60) are divergent and a cross-sectional area of the first light beam (54) is smaller at a pre-determined distance from the lamp than a cross-sectional area of the second light beam (56) at the pre-determined distance.

7. A mobile lamp in accordance with claim 1, characterized in that the at least one image producing device of at least one of the lighting units includes a focusing optical component and is made such that the light of the corresponding lighting unit can be focused at a pre-determined distance onto an area orthogonal to the radiation direction.

8. A mobile lamp in accordance with claim 1, characterized in that the lighting units (58, 60) are made such that a light spot with an area between 1 m² and 4 m² can be produced by means of the first lighting unit (58) on a first area oriented orthogonally to the first propagation direction (A) at a distance of approximately 10 m and that a light spot (114) with an area between 0.4 m² and 2 m² can be produced by means of the second lighting unit (60) on a second area oriented orthogonally to the second propagation direction at a distance of approximately 1 m.

9. A mobile lamp in accordance with claim 1, characterized in that the image producing devices include lenses (42, 44) spaced apart from the light emitting diode elements.

10. A mobile lamp in accordance with claim 1, characterized in that the first and/or second light units (58, 60) each include at least two light emitting diode elements (30, 34) and at least two corresponding image producing devices (42, 44).

11. A mobile lamp in accordance with claim 10, characterized in that the image producing devices (42, 44) are formed by at least two light emitting diode elements (30, 34) of one of the lighting units (58, 60) such that a pre-determined area (106, 108) can be illuminated at a pre-determined distance from the mobile lamp by light beams (104, 104′, 110) of said light emitting diode elements (30, 40).

12. A mobile lamp in accordance with claim 1, characterized in that the light emitting diode elements (30, 34) are light emitting diode elements for the emission of substantially white light.

13. A mobile lamp in accordance with claim 1, characterized in that the lamp is made as a vehicle lamp, in particular as a bicycle lamp.

14. A mobile lamp in accordance with claim 1, characterized in that the lamp is made as a head lamp.

15. A mobile lamp in accordance with claim 1, characterized in that the lamp has an areal support element (24) which is pivotable relative to the lighting units (58, 60) in a plane which is aligned substantially parallel to the first and second radiation directions (A, A′).

16. A mobile lamp in accordance with claim 15, characterized in that a housing (18) is provided in which the lighting units (58, 60) are arranged, and in that latch elements (72, 74, 76, 78) complementary to one another are arranged at the housing (18) and at the support element (24) by means of which the support element (24) can be secured in its relative position to the housing (18).

17. A mobile lamp in accordance with claim 1, characterized by a housing (18) for the reception of the lighting units (58, 60) and by two lugs (88, 86′) which are arranged at opposing sides of the housing (18), are connected to the housing (18) and at which an elastic band (10) can be held for the fastening of the lamp to an object or to a head of a person and which are so flexible that their shape can be matched to the shape of the object or of the head by the tension of the elastic band (10) on being secured to the object or to the head.

18. A mobile lamp in accordance with claim 1, characterized in that the lighting units are arranged in a housing in which a battery compartment is provided.

19. A mobile lamp in accordance with claim 1, characterized in that the lighting units (58, 60) are held at an elastic band (10) in a housing (18); and in that a battery holder (14) is held at the band (10).
